(19) United States
(12) Patent Application Publication
(10) Pub. No.: US 2004/0237745 A1
(43) Pub. Date: Dec. 2, 2004

(54) Paper cutter with self-supporting cutting arm secured by snap ring

(75) Inventors: Charles Lemuel Dellinger, Mooresville, NC (US); Gary Keith Post, Hamptonville, NC (US)

Correspondence Address: MCNEES, WALLACE & NURICK, 100 PINE STREET, P.O. BOX 1166, HARRISBURG, PA, 17108-1166, US

(73) Assignee: Hunt Holdings, Inc., Wilmington, DE

(21) Appl. No.: 10/778,722

(22) Filed: Feb. 13, 2004

Related U.S. Application Data
(60) Provisional application No. 60/447,534, filed on Feb. 14, 2003.

(51) Int. Cl. B26D 1/30

(52) U.S. Cl. 83/607; 83/698.11

(57) ABSTRACT

A paper cutter including a cutting arm having a pivot pin that allows for locking to the paper cutter's base using a snap/retaining ring. The snap ring retains the cutting arm on the base while permitting pivotal motion. No threaded parts, nuts or lock nuts are required. The mounting boss may include an internal surface that is configured to cause an interference fit with the pivot pin, and corresponding friction. Such friction and/or interference between the mounting boss and pivot pin is sufficient to support the cutting arm, and any blade, in an elevated position above the base to prevent falling of the cutting arm/blade and resulting injury to a user. The pivot pin may be integrally formed with the cutting arm as a unit, e.g. by injection molding with a synthetic resin.

### CROSS-REFERENCE TO RELATED APPLICATION

This application claims the benefit of U.S. Provisional Patent Application No. 60/447,534, filed Feb. 14, 2003, the entire disclosure of which is hereby incorporated herein by reference.

### FIELD OF THE INVENTION

The present invention relates generally to a cutter for sheet material having a blade bearing pivotable cutting arm mounted to a cutting board, and more particularly to a cutting arm that is securable to the cutting board without the need for one or more threaded lock nuts, and that can support itself in a raised position without the need for a spring or other additional parts.

### DISCUSSION OF RELATED ART

Cutters or trimmers for sheet material, typically referred to as paper cutters, are in widespread use in educational, institutional, commercial, corporate and other environments for cutting paper, cardboard or sheets of other materials. An exemplary paper cutter has a flat cutting board base that has a sharp cutting edge on a side of the base, and a cutting arm pivotally mounted to the base adjacent the sharp cutting edge. The cutting arm supports a sharp blade that cooperates with the cutting edge on the side of the base to cut any sheets therebetween when the cutting arm is pivoted to draw its blade along the cutting edge in a scissor-like action. Exemplary paper cutters are shown in U.S. Pat. No. 2,256,606 to Blanc, U.S. Pat. No. 2,327,000 to Lund, U.S. Pat. No. 2,345,450 to Blanc, U.S. Pat. No. 2,460,842 to Murphy et al., and U.S. Pat. No. 2,591,472 to Segal. These paper cutters are exemplary of many well-known paper cutters in which the cutting arm is attached to the base by a pivot pin having external threads for mating with internal threads of a complementary nut. This pivot pin is attached at one of its ends to the cutting arm. The pivot pin's other end extends through a mounting boss of the base. The pivot pin (and cutting arm) is secured to the base by threading a first nut onto the threaded end of the pivot pin, which has threads complementary to those of the first nut. A second nut is typically threaded onto the pivot pin and tightened against the first nut, thereby acting as a lock nut to lock the first nut and pivot pin in place. These nuts, and the assembly steps associated with providing such nuts in a finished product, add to the parts and manufacturing/assembly costs of the paper cutter.

The Blanc and Lund patents identified above are further representative of many well-known paper cutters in that a spring is provided to bias the pivotable cutting arm, and the blade supported thereon, toward an upper position, or to maintain the cutting arm in an upper/raised position, to prevent the cutting arm and blade from falling downwardly and causing injury to the user or another. Such spring(s) support the cutting arm only in a single, typically uppermost, position.

Accordingly, conventional paper cutter arrangements require numerous parts, and numerous assembly steps to install such parts, and therefore add undesirably to the manufacturing costs for the paper cutter.

What is needed is a cutting arm/pivot pin arrangement that reduces or eliminates these undesirable parts, assembly steps and/or costs, and/or provides a cutting arm capable of supporting itself in a plurality of angular positions.

### SUMMARY OF THE INVENTION

The present invention provides a pivot pin, and/or a cutting arm including a pivot pin, that allows for locking to the cutting board using a snap ring (sometimes referred to as a “retaining ring”), such as a conventional “e-clip” or “e-ring”, that can be pushed onto the pivot pin in a simple assembly step, without the need for threading.

The mounting boss of the cutting board is optionally configured to have an irregular surface, i.e. a non-cylindrical surface, such as a substantially cylindrical surface having a plurality of flat sides, that causes an interference fit and corresponding friction between the mounting boss and the pivot pin at a plurality of rotational positions of the pivot pin relative to the mounting boss, and hence at a plurality of angular positions of the cutting arm, such that the friction and/or interference between the mounting boss and pivot pin is sufficient to support the cutting arm and blade supported thereon in a plurality of angular positions to prevent falling of the cutting arm and injury to a user, etc.

The present invention thereby eliminates the need for one or more lock nuts, a supportive spring, and corresponding assembly steps and costs.

A cutting arm in accordance with the present invention has a pivot pin extending transversely to a direction of elongation of the cutting arm. Optionally, the pivot pin is integrally formed with the cutting arm as a unit, e.g. by injection molding with a synthetic resin, to further reduce parts and/or assembly costs. The pivot pin has a first section having a relatively small cross section, and a second section having a relatively large cross section, the second section being positioned between the first section end a distal end of the pivot pin. Preferably, the pivot pin has a uniform cylindrical or substantially cylindrical cross section along most of its length, and the first section includes a portion of the pivot pin that has a reduced, cylindrical or substantially cylindrical cross section. The snap ring is configured to engage the first section of the pivot pin and form a friction fit therewith when pushed onto the pivot pin in a direction transverse to a direction of elongation of the pivot pin, and to have structure, e.g. legs, that will interfere with the second section of the pivot pin to prevent sliding of the snap ring in a direction of elongation of the pivot pin to prevent slipping of the snap ring off the distal end of the pivot pin.

A cutting arm assembly for a paper cutter is also provided which includes such a cutting arm and a snap ring having internal legs configured to be complementary to the first section of the pivot pin.

A paper cutter including such a cutting arm assembly and a method for assembling such a paper cutter are also provided.

### DESCRIPTION OF THE DRAWINGS

FIG. 1 is a perspective view of a cutting arm in accordance with an exemplary embodiment of the present invention;

FIG. 1A is a plan view of a snap ring for interfitting with the cutting arm of FIG. 1 in accordance with the present invention;

FIG. 1B is an end view of the snap ring of FIG. 1A shown interfitted on the cutting arm of FIG. 1;

FIG. 2 is a top view of the cutting arm and snap ring of FIGS. 1A-1B;

FIG. 3 is an enlarged plan view of an alternative embodiment of a pivot pin in accordance with the present invention;

FIG. 4 is a perspective view of a paper cutter in accordance with an exemplary embodiment of the present invention;

FIG. 5 is a bottom view of the paper cutter of FIG. 4, showing mounting of the cutting arm of FIG. 1 using the snap ring of FIG. 1A;

FIG. 6 is a partial cross sectional view taken along line 6-6 of FIG. 5, showing an alternative embodiment of the mounting boss of the paper cutter of FIGS. 4 and 5;

FIG. 7 is a partial enlarged plan view of yet another alternative embodiment of a pivot pin for interfitting with the mounting boss of FIG. 6; and

FIG. 8 is an end view of an alternative embodiment of the mounting boss of FIG. 6, showing interfitting relationship to the pivot pin of FIG. 7.

### DETAILED DESCRIPTION

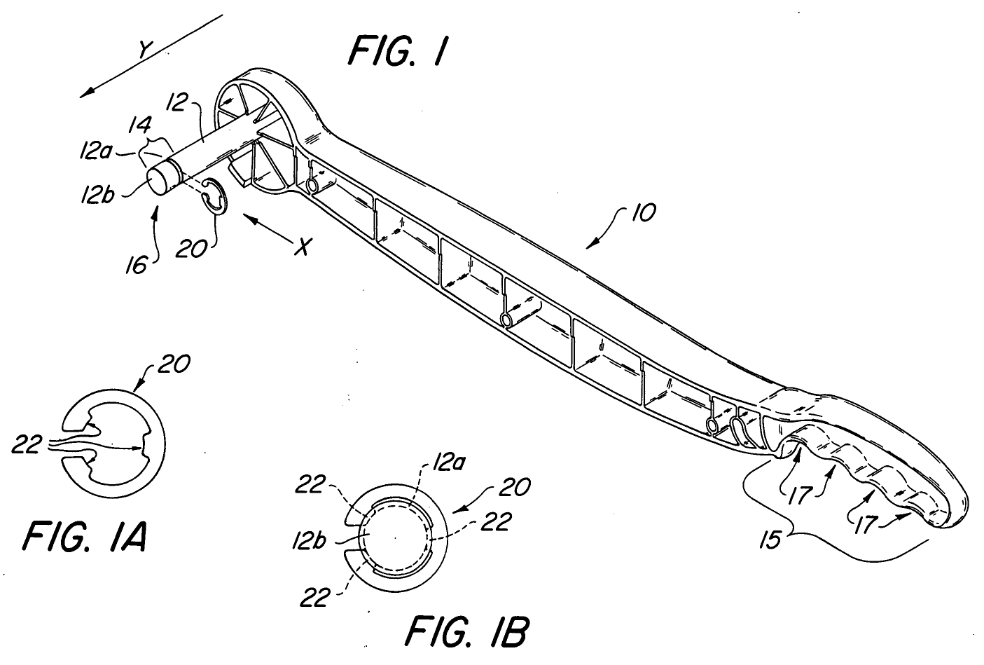

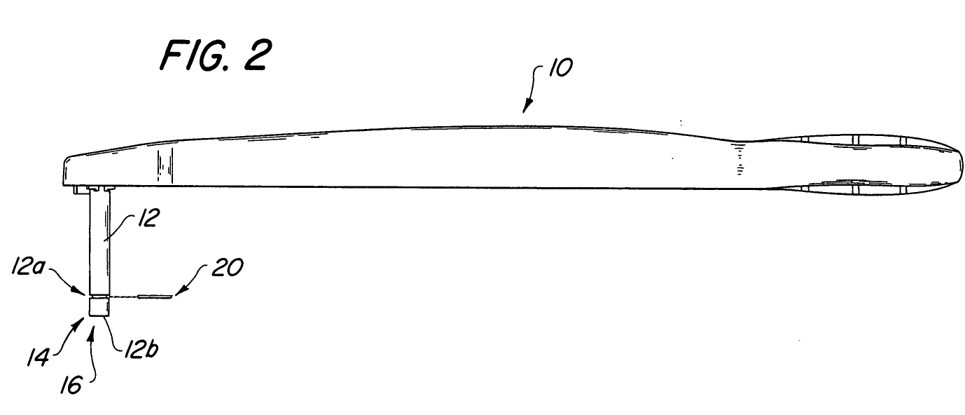

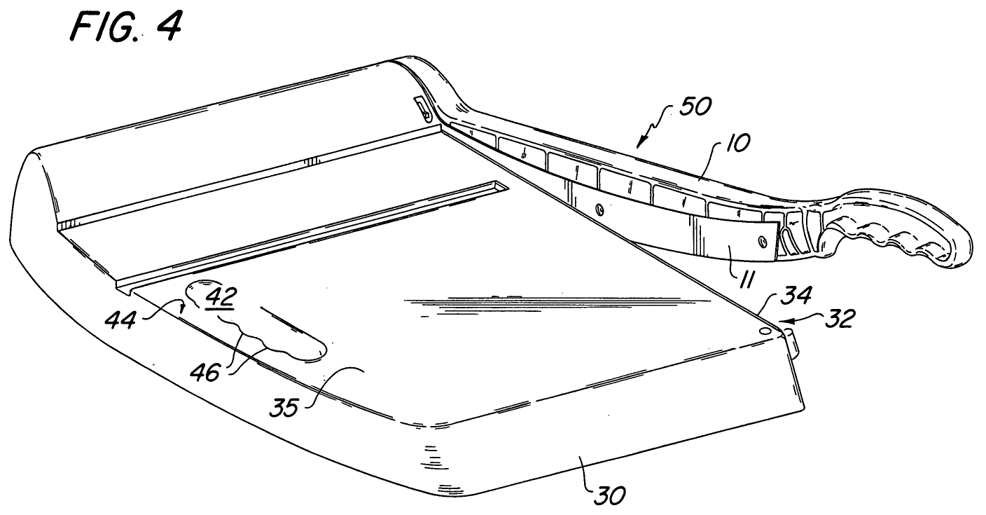

FIGS. 1 and 2 show an elongated cutting arm member 10 having a pivot pin 12 in accordance with an exemplary embodiment of the present invention that may be incorporated into a paper cutter 50 (see FIG. 4) of a type generally known in the art. Such a paper cutter 50 includes a base 30 having a surface 35 for supporting paper of other sheets to be cut, and a cutting arm 10 pivotally mounted at one end to the base 30 for pivotal motion in a substantially vertical plane. The cutting arm 10 has a blade 11 supported thereon, such as a steel blade, for cutting sheet material in cooperation with a cutting edge 34 of the base 30. Optionally, the cutting arm 10 may include a handle portion 15 that includes arcuate finger holds 17 for interfitting with an individual's fingers.

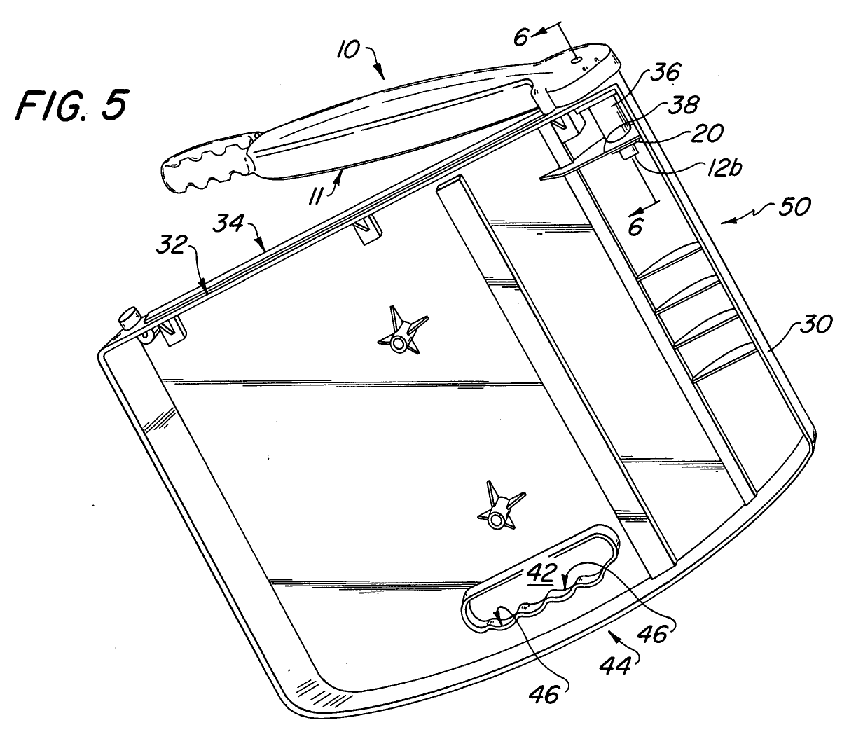

As shown in FIGS. 1, 2 and 4, the cutting arm 10 is of a type generally known in the art as a component of a paper cutter in that it is elongated in a longitudinal direction and configured for supporting an elongated blade 11 for cutting sheet material, and has a pivot pin 12. As generally known in the art, the pivot pin 12 extends transversely to a direction of elongation of the cutting arm 10 for pivotally mounting the cutting arm 10 to a base of the paper cutter for pivotal motion in a substantially vertical plane, as best shown in FIGS. 1 and 2. In the embodiment shown, the pivot pin 12 is integrally formed with the cutting arm as a unit, e.g. by injection molding with a synthetic resin, to further reduce parts and/or assembly costs. An exemplary paper cutter including the cutting arm 10 is shown in FIGS. 4 and 5.

In accordance with the present invention, a distal portion 14 of the pivot pin 12 has a first section 12a having a relatively small cross section, and a second section 12b having a relatively large cross section. The second section 12b is positioned between the first section 12a and a distal end 16 of the pivot pin 12. Preferably, the pivot pin 12 has a uniform cylindrical or substantially cylindrical cross section along most of its length, and the first section 12a includes a portion of the pivot pin 12 that has a reduced, cylindrical or substantially cylindrical cross section.

FIGS. 1A, 1B and 2 show a snap ring 20, in this example an e-clip/e-ring, configured to receive the first section 12a of the pivot pin 12 and form a friction fit therewith when pushed onto the pivot pin 12 in a direction X transverse to a direction of elongation Y of the pivot pin (see FIG. 1), and to have structure 22 that will interfere with the second section 12b of the pivot pin 12 to prevent sliding of the snap ring 20 in a direction of elongation Y of the pivot pin such that the snap ring 20 could slip off the distal end 16 of the pivot pin 12. The structures 22 cooperate to define a region for receiving the first section 12a of the pivot pin 12 in an interference or friction fit, such that the snap ring 20 will expand sufficiently to snap onto, and be positively retained on, the first section 12a of the pivot pin 12. Such e-clip type snap rings, which are generally made of metal, and other suitable snap rings, e.g. c-clip type snap rings, are generally known in the art.

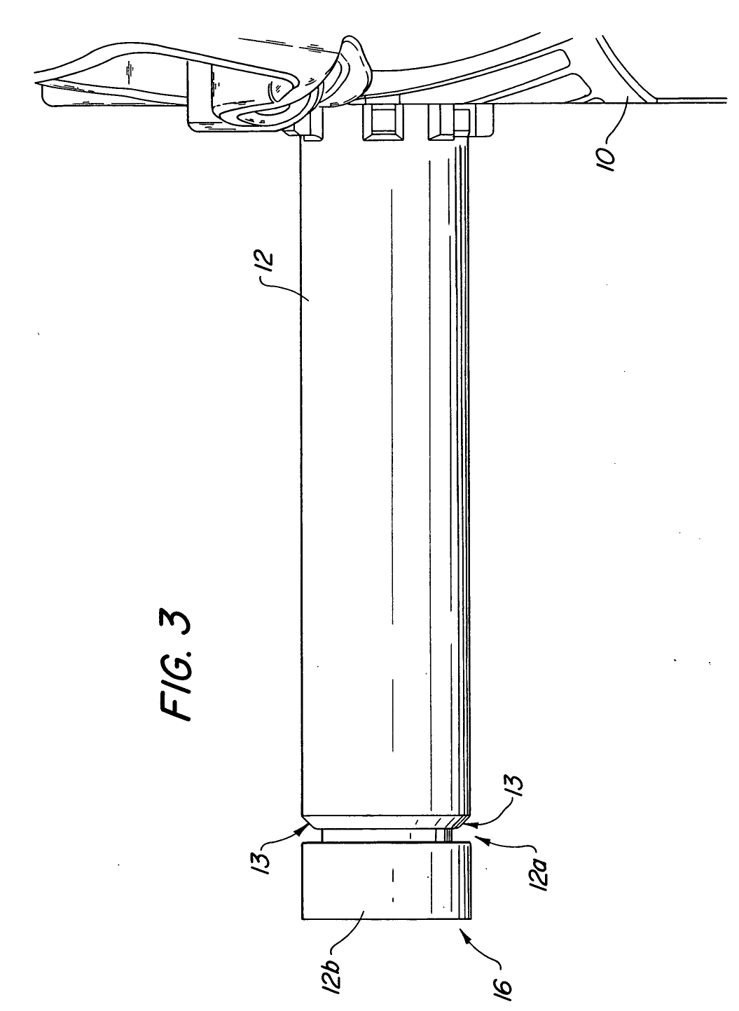

FIG. 3 shows an alternative embodiment of the pivot pin 12 that includes a tapered shoulder 13 that is tapered from the full diameter of the pivot pin 12 toward the reduced diameter of the first section 12a. This configuration facilitates mounting of the snap ring 20 to the pivot pin 12 by guiding the snap ring 20 into its proper position in the first section 12a as the snap ring 20 is pressed onto the pivot pin 12. Preferably, the tapered shoulder 13 is adjacent the proximal edge of the first section 12a, i.e. opposite the distal end 16 relative to the first section 12a.

FIG. 4 is a perspective view of a paper cutter 50 in accordance with an exemplary embodiment of the present invention. As discussed above, the paper cutter 50 of FIG. 4 is typical of those generally known in the art in that it includes a base 30 having a side 32 bearing a cutting edge 34 and a top surface 35 for supporting sheet material to be cut, and a cutting arm 10 pivotally mounted to the base 30 for pivotal motion in a substantially vertical plane. The cutting arm 10 supports a blade 11 for cutting sheet material. For example, the blade 11 may be fastened to the cutting arm 10 by screws or by injection molding the cutting arm to interlock with the blade 32. The base 30 and cutting arm 10 may be formed primarily of a synthetic resin, e.g. by injection molding, to provide a relatively lightweight and low cost paper cutter.

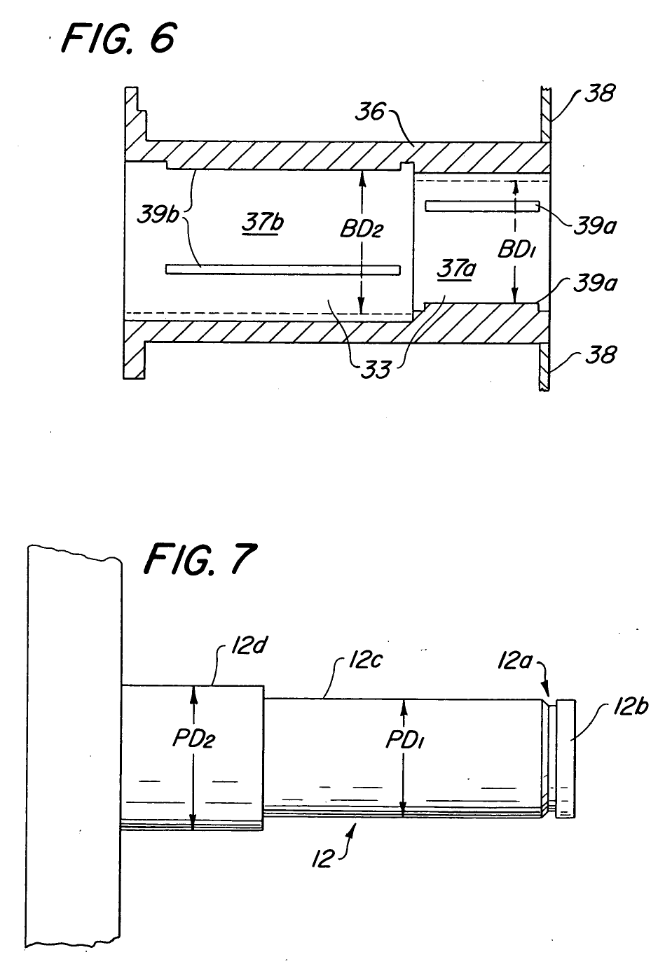

FIG. 5 is a bottom view of the paper cutter 50 of FIG. 4, showing mounting of the cutting arm 10 of FIG. 1. As shown in FIG. 5, the base 30 has a mounting boss 36 adjacent the cutting edge 34 that has an internal opening (not shown in FIG. 5) for receiving the pivot pin 12. The mounting boss 36 is discussed in greater detail below with reference to FIGS. 6-8. The first section 12a of the pivot pin 12 is positioned to extend just beyond a stop surface 38 of the mounting boss 36 when the pivot pin is positioned to extend through the mounting boss 36, as shown in FIG. 5.

The snap ring 20 is snapped onto the first section 12a of the pivot pin 12. When the snap ring 20 is fastened to the pivot pin 12, the snap ring's interference with the stop surface 38 serves to fasten the cutting arm 10 to the base 30. The snap ring 20 may be quickly and easily assembled to the pivot pin 12 without the need for threading of one or more nuts, without nut driving or other tools, and without the need for supplemental parts analogous to a nut and lock nut. Therefore, this arrangement allows for locking of the cutting arm 10 and/or pivot pin 12 without the need for one or more nuts and related assembly steps and/or tooling, and provides for reduction of certain manufacturing costs.

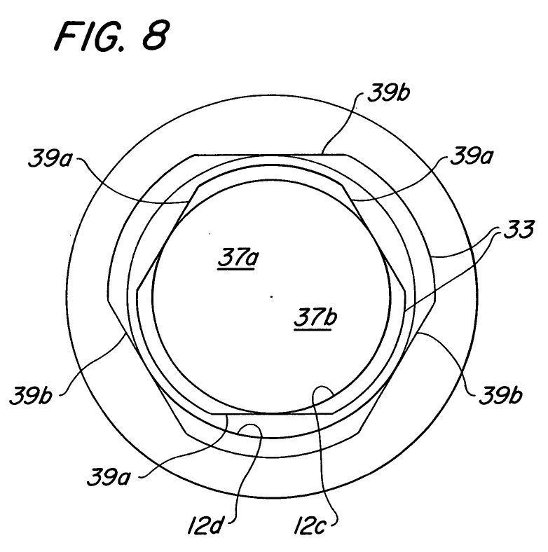

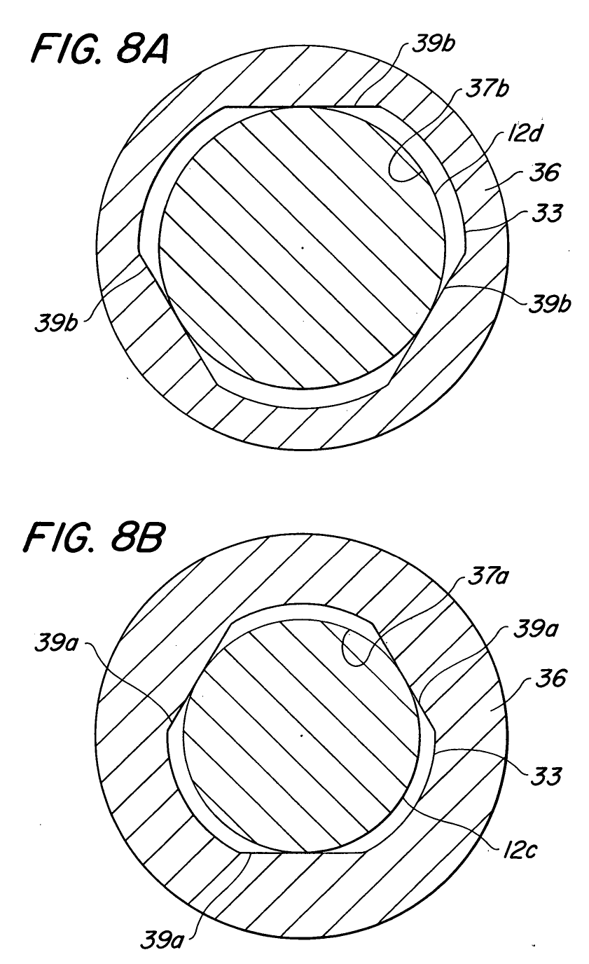

In certain embodiments, the mounting boss 36 may have a cylindrical or substantially cylindrical internal opening complementary to the pivot pin 12. However, it is preferable that the mounting boss 36 have an internal opening having a specially configured irregular surface 33, i.e. a non-cylindrical surface that causes friction between the mounting boss 36 and the pivot pin 12 such that the friction and/or interference between the mounting boss 36 and pivot pin 12 is sufficient to support the cutting arm 10 and blade supported thereon in a plurality of angular positions relative to the base 30 to prevent falling of the cutting arm 10 and injury to a user, etc. For example, the internal surface 33 of the mounting boss 36 may have a plurality of discrete bumps or ridges extending longitudinally of the mounting boss, as shown as 39a or 39b of FIG. 6. Alternatively, the internal surface 33 may be generally cylindrical but have a plurality of longitudinally extending flats 39a, 39b that define chords of the generally cylindrical surface 33, as shown in the alternative embodiment of FIG. 8. Optionally, the bumps, ridges or flats extend along the entire length of the internal opening (not shown). The bumps, ridges, flats, etc. are preferably evenly distributed along the surface 33, e.g. at 120 degree intervals around the circular cross section, as shown in FIGS. 6 and 8. Dimensions of the internal surface/bumps, ridges, flats, etc., and the pivot pin are selected to cause an interference fit therebetween such that the pivot pin 12 and/or mounting boss 36 may distort upon assembly, will provide sufficient friction to support the cutting arm in any desired angular position, and yet is easily operable by the user as desired. For example, dimensions providing approximately 0.003 inches of interference between the pivot pin 12 and the bumps, ridges, flats, etc. has been found suitable for a pivot pin 12 constructed of 43% glass filled type 6 nylon and a mounting boss 36 constructed of high impact polystyrene for a range of cutting arm/blade weights. For example, BD₁ may be selected to be PD₁+0.003 inches, as shown in FIGS. 6 and 7. As will be appreciated from FIG. 8, the pivot pin 12 then contacts, and rides in an area defined by, the bumps, ridges, flats, 39a/39b etc.

In the exemplary embodiments of FIGS. 6-8, the internal opening has a stepped internal surface to provide at least two internal opening portions of different sizes. Such a configuration is advantageous for manufacturing purposes, as discussed below. FIG. 6 shows an exemplary internal opening of the mounting boss 36 having a stepped internal surface 33 providing two internal opening portions 37a, 37b. In such an embodiment, the pivot pin 12 preferably has a stepped external surface to define two portions of different sizes, 12c, 12d, as shown in FIG. 7. Each portion of the pivot pin 12c, 12d is sized to be complementary to a corresponding portion of the internal opening 37a, 37b, e.g. to provide approximately 0.003 inches of interference, as discussed above. Preferably, the stepped portions do not align in a lengthwise direction of the pivot pin 12 and internal opening, but rather are spaced such that as the pivot pin 12 is inserted axially into the mounting boss 36 during assembly, the stepped down portion 12c of the pivot pin 12 begins to enter and interfere with the stepped down portion 37 of the internal opening of the mounting boss 36 at approximately the same time that the stepped up portion 12d of the pivot pin 12 begins to enter and interfere with the stepped up portion 37b of the internal opening of the mounting boss 36, as can be seen from FIGS. 6 and 7. In this manner, the stepped down portion 12c of the pivot pin 12 can be inserted into the stepped up portion 37b of the mounting boss 36 with virtually no resistance during a first stage of assembly. Since this first stage of assembly is typically performed manually, this is desirable for the assembly worker to prevent difficulty, injury, etc. Then, powered machinery, such as a hydraulic or pneumatic press, is used in a second stage of the assembly process to perform the relatively difficult task of forcing together the pivot pin 12 and mounting boss 36 to cause the desired interference fit between stepped down portions 12c and 37a and between stepped up portions 12d and 37b.

A paper cutter having a cutting arm, a base for supporting material to be cut and a mounting boss for supporting a cutting arm having a blade, may be assembled in accordance with the present invention as follows. First, a pivot pin 12 of the cutting arm 10 is positioned to extend through the mounting boss 36 of the base 30, which may include the two-stage assembly process described above. In some embodiments, this requires assembly of the pivot pin 12 to the cutting arm 10 to cause the pivot pin 12 to extend transversely to a direction of elongation of the cutting arm 10. In the preferred embodiment, the pivot pin and cutting arm are integrally formed as a unit to further reduce parts and assembly costs.

The snap ring 20 having structures defining a region complementary to the pivot pin's first section 12a is then advanced onto the first section 12a of the pivot pin 12 by forcing the snap ring onto the first section 12a until it snaps into place. For example, this may be performed by manual force.

Optionally, the paper cutter 50 may include an integral handle 44 for carrying the paper cutter 50. The integral handle 44 is formed as an integral part of the base 30. More specifically, the base defines an opening 42 internal to a perimeter of the base 30, such that the opening 42 extends through the base 30 to allow an individual's fingers to pass therethrough, as shown in FIGS. 4 and 5. In a preferred embodiment, the base 30 is contoured such that the opening 42 defines a plurality of arcuate finger holds 46 for interfitting with the individual's fingers, as shown in FIGS. 4 and 5. For example, base 30 may be injection molded to define the opening 42, handle 44 and finger holds 46.

Optionally, the present invention may include a structural safety latch or burr-edged blade as disclosed in U.S. Provisional Patent Application No. 60/395,007 filed Jul. 11, 2002, U.S. patent application Ser. No. ______ (Attorney Docket No. P25,964 USA), now U.S. Pat. No. ______, the disclosure of which is hereby incorporated herein by reference.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A cutting arm assembly for a paper cutter, said paper cutter having a base for supporting sheet material to be cut, said cutting arm assembly comprising:
an elongated member configured to support a cutting blade for cutting sheet material, the member extending in a longitudinal direction;
a pivot pin joined to said member and extending transversely to said longitudinal direction, said pivot pin having a distal end, a first section having a first cross-sectional area, and a second section having a second cross-sectional area, said second cross-sectional area being larger than said first cross-sectional area, said second section being positioned between said first section and said distal end; and
a snap ring configured to interfit with said first section of said pivot pin, said snap ring having resilient legs that are capable of resiliently diverging to permit mounting of said snap ring onto said first section, and that are capable of resiling to retain said snap ring on said first section, said legs being configured to interfere with said second section to resist sliding of said snap ring along said pivot pin.

2. The cutting arm assembly of claim 1, further comprising a blade mounted to said member.

3. The cutting arm assembly of claim 1, wherein said pivot pin and said member are formed as a unitary body by an injection molding process.

4. The cutting arm assembly of claim 1, wherein said first section comprises a portion of the pivot pin having a substantially cylindrical cross section.

5. The cutting arm assembly of claim 1, wherein said pivot pin comprises a shoulder portion adjacent said first section, said shoulder portion being tapered toward said first section.

6. The cutting arm assembly of claim 1, wherein said snap ring is mounted on said first section.

7. The cutting arm assembly of claim 1, wherein said member includes a handle portion comprising a plurality of arcuate finger holds for interfitting with the individual's fingers.

8. A paper cutter comprising:
a base for supporting material to be cut, said base having a side bearing a cutting edge; and
a cutting arm assembly according to claim 1, said member supporting a blade for cooperating with said cutting edge to cut sheet material positioned on said base, said member being pivotally mounted to said base for pivotal motion in a substantially vertical plane, said snap ring being mounted on said first section of said pivot pin to pivotally mount said cutting arm to said base.

9. A paper cutter comprising:
a base for supporting material to be cut, said base having a side bearing a cutting edge and a mounting boss adjacent said cutting edge, said mounting boss defining an internal opening therethrough;
an elongated cutting arm member configured to support a cutting blade for cooperating with said cutting edge to cut sheet material positioned on said base, said member extending in a longitudinal direction;
a pivot pin joined to said member and extending transversely to said longitudinal direction, said pivot pin having a distal end, a first section having a first cross-sectional area, and a second section having a second cross-sectional area, said second cross-sectional area being larger than said first cross-sectional area, said second section being positioned between said first section and said distal end; and
a snap ring configured to interfit with said first section of said pivot pin, said snap ring having resilient legs that are capable of diverging to permit mounting of said snap ring onto said first section, and that are capable resiling to cause said snap ring to be retained on said first section, said legs being configured to interfere with said second section to resist sliding of said snap ring;
said pivot pin extending through said mounting boss, said snap ring being mounted to said first section of said pivot pin, said cutting arm member being thereby pivotally mounted to said base for pivotal motion in a substantially vertical plane to cut sheet material positioned on said base.

10. The paper cutter of claim 9, further comprising a blade mounted to said elongated member.

11. The paper cutter of claim 9, wherein said pivot pin and said member are formed as a unitary body by an injection molding process.

12. The paper cutter of claim 9, wherein said pivot pin comprises a shoulder portion adjacent said first section, said shoulder portion being tapered toward said first section.

13. The paper cutter of claim 9, wherein said snap ring comprises an e-clip.

14. The paper cutter of claim 10, wherein said internal opening of said mounting boss and said pivot pin are dimensioned to form an interference fit therebetween, whereby friction between said mounting boss and said pivot pin is sufficient to support said cutting arm member and said blade against gravity, and to thereby retain said cutting arm in a position in which at least a portion of said blade is disposed above said base.

15. The paper cutter of claim 14, said internal opening being substantially cylindrical in shape, said mounting boss defining a plurality of discrete flats arranged as chords of said cylindrical opening, said plurality of discrete flats forming said interference fit with said pivot pin.

16. The paper cutter of claim 14, said mounting boss having a plurality of discrete ridges extending within said internal opening, said plurality of discrete ridges forming said interference fit with said pivot pin.

17. The paper cutter of claim 16, each of said plurality of discrete ridges extending longitudinally of said mounting boss.

18. The paper cutter of claim 15, wherein said internal opening has an internal surface contoured to provide a stepped down portion having a cross-sectional area smaller than an adjacent portion of said internal opening, said pivot pin having an external surface contoured to provide a stepped down portion having a cross-sectional area smaller than an adjacent portion of said pivot pin.

19. The paper cutter of claim 18, wherein said pivot pin and said internal opening are configured to cause said stepped down portion of said pivot pin to enter and interfere with said stepped down portion of said internal opening at approximately a longitudinal position of said pivot pin relative to said mounting boss at which said adjacent portion of said pivot pin begins to enter and interfere with said adjacent portion of said internal opening.

20. The paper cutter of claim 9, wherein said base defines an opening internal to a perimeter thereof, said opening extending through said base to allow an individual's fingers to pass therethrough.

21. The paper cutter of claim 20, wherein said opening defines a plurality of arcuate finger holds for interfitting with the individual's fingers.

22. A paper cutter comprising:
a base for supporting material to be cut, said base having a side bearing a cutting edge and a mounting boss adjacent said cutting edge, said mounting boss defining an internal opening therethrough;
an elongated cutting arm member supporting a cutting blade, said member being pivotally mounted to said base for pivotal motion in a substantially vertical plane to cause said cutting blade to cooperate with said cutting edge to cut sheet material positioned on said base, said member extending in a longitudinal direction;
a pivot pin joined to said member and extending transversely to said longitudinal direction, said pivot pin being dimensioned to form an interference fit with said internal opening of said mounting boss, whereby friction between said mounting boss and said pivot pin is sufficient to support said cutting arm member and said blade against gravity, and to thereby retain said cutting arm member in a position in which at least a portion of said blade is disposed above said base.

23. A method for assembling a paper cutter, said method comprising:
providing a base for supporting material to be cut, said base having a side bearing a cutting edge and a mounting boss adjacent said cutting edge, said mounting boss defining an internal opening therethrough;
providing an elongated member configured to support a cutting blade for cutting sheet material, the member extending in a longitudinal direction, said elongated member comprising a pivot pin extending transversely to said longitudinal direction, said pivot pin having a distal end, a first section having a first cross-sectional area, and a second section having a second cross-sectional area, said second cross-sectional area being larger than said first cross-sectional area, said second section being positioned between said first section and said distal end;
inserting said pivot pin through said mounting boss until said first section is exposed; and
mounting a snap ring to the first section of the pivot pin to cause said cutting arm member to be pivotally mounted to said base.

24. The method of claim 23, wherein said inserting comprises:
manually inserting said pivot pin into said pivot pin; and
operating powered equipment to forcibly advance said pivot pin into said mounting boss to cause an interference fit therebetween.
